(19) United States
(12) Patent Application Publication
(10) Pub. No.: US 2011/0169884 A1
(43) Pub. Date: Jul. 14, 2011

(54) METHOD FOR FORMING CONDUCTOR PATTERN, WIRING BOARD, AND LIQUID DROPLET EJECTING APAPRATUS

(75) Inventors: Naoyuki TOYODA, Suwa (JP); Toshiyuki KOBAYASHI, Chino (JP); Noboru UEHARA, Okaya (JP); Yoshikazu HAMA, Okaya (JP); Kentaro TANABE, Chino (JP)

(73) Assignee: SEIKO EPSON CORPORATION, Tokyo (JP)

(21) Appl. No.: 13/005,061

(22) Filed: Jan. 12, 2011

(30) Foreign Application Priority Data
Jan. 13, 2010 (JP) 2010-005343

(51) Int. Cl. B41J 29/38

(52) U.S. Cl. 347/9

(57) ABSTRACT

A method for forming a conductor pattern includes: forming a conductor pattern precursor by ejecting liquid droplets of a conductor pattern forming ink by a liquid droplet ejecting method onto a substrate, and drying the liquid droplets, thereby forming a conductor pattern precursor having a pad part and a wiring part connected to the pad part on the substrate; and firing the precursor, thereby forming the conductor pattern, wherein in the formation of the conductor pattern precursor, the liquid droplets of the conductor pattern forming ink are ejected in such a manner that positions where the liquid droplets of the conductor pattern forming ink are attached form plural concentric annular shapes within a pad forming region where the pad part is to be formed on the substrate.

### BACKGROUND

1. Technical Field

The present invention relates to a method for forming a conductor pattern, a wiring board, and a liquid droplet ejecting apparatus.

2. Related Art

Wirings used in an electronic circuit and an integrated circuit are produced, for example, by a photolithography method. In the photolithography method, a photosensitive material, which is referred to as a resist, is coated on a substrate having been coated with an electroconductive film in advance and irradiated with a circuit pattern and developed, and the electroconductive film is etched according to the resist pattern, thereby forming a wiring formed of the conductor pattern. The photolithography method requires large-scale equipments including a vacuum apparatus and a complicated process steps, and most of the materials used is wasted due to the low material use efficiency of several percents, which increases the production cost.

On the other hand, a liquid droplet ejecting method, in which a liquid material is ejected in the form of liquid droplets from a liquid ejecting head, i.e., a so-called ink-jet method, is proposed for forming a conductor pattern (wiring) (see, for example JP-A-2007-84387). In this method, a conductor pattern forming ink containing electroconductive fine particles dispersed therein is coated patternwise directly on a substrate, and then the solvent is removed to provide a conductor pattern precursor, which is fired to convert to a conductor pattern. The ink-jet method provides such advantages that photolithography is not required, the process steps are greatly simplified, and the amounts of the raw materials used can be decreased. The ink-jet method can produce a finer conductor pattern than the ordinary methods and thus is advantageous for enhancing the circuit density.

However, in the case where a conductor pattern containing a pair of pad parts and a wiring part connecting the pad parts is to be formed, a conductor pattern formed by the ink-jet method may suffer cracking, breakage of wiring or the like.

This is because as follows. Upon forming a conductor pattern precursor having a relatively large thickness, it is necessary to eject a large amount of a conductor pattern forming ink on a substrate, and therefore, the conductor pattern forming ink is necessarily accumulated sequentially on the substrate. In this case, the thickness of the ink on the substrate may be fluctuated due to the surface tension and the flowage of the ink derived from inner pressure on drawing or after drawing, the thickness of the conductor pattern precursor in the portion corresponding to the pad parts may be larger than the thickness thereof in the portion corresponding to the wiring part. This tendency is magnified when the dimension of the pad part (which is the diameter for the pad part with circular shape or the edge length for the pad part with square shape) becomes larger, or the wiring part becomes thinner, i.e., when the difference between the dimension of the part and the width of the wiring part becomes larger. The fluctuation in thickness is hard to occur with a high-viscosity ink, such as a paste, and thus is a phenomenon that is peculiar to a low-viscosity ink. The fluctuation in thickness may also depend on the pattern, for example, the difference in thickness is increased when the distance between the pad parts is smaller or the number of the wiring part is larger because of the inner pressure, and thus is a major issue in a random pattern.

The portion corresponding to the wiring part of the conductor pattern precursor with a smaller thickness is weak against stress and thus may easily suffer cracking due to thermal expansion and contraction stress of the substrate upon firing, which breaks the conductor pattern. In the high-temperature firing process for producing a ceramics circuit board or the like, the wiring part formed of metal nanoparticles is partially evaporated and is decreased in thickness, whereby the wiring part may be further thinned and easily broken or may be largely increased in resistance. As having been described above, it has been difficult to enhance sufficiently the reliability and yield of the conductor pattern (i.e., the wiring board).

### SUMMARY

An advantages of some aspects of the invention is to provide a method for forming a conductor pattern capable of preventing occurrence of cracking, breakage of wiring or the like and forming a conductor pattern with high reliability, to provide a wiring board with high reliability having the conductor pattern, and to provide a liquid droplet ejecting apparatus that can be favorably used for forming the conductor pattern.

According to an aspect of the invention, there is provided a method for forming a conductor pattern, including:

forming a conductor pattern precursor by ejecting liquid droplets of a conductor pattern forming ink by a liquid droplet ejecting method onto a substrate, and drying the liquid droplets, thereby forming a conductor pattern precursor having a pad part and a wiring part connected to the pad part on the substrate; and

firing the precursor, thereby forming the conductor pattern,

wherein in the formation of the conductor pattern precursor, the liquid droplets of the conductor pattern forming ink are ejected in such a manner that positions where the liquid droplets of the conductor pattern forming ink are attached form plural concentric annular shapes within a pad forming region where the pad part is to be formed on the substrate.

According to the aspect, the difference in thickness between the portion corresponding to the pad part and the portion corresponding to the wiring part of the conductor pattern precursor can be decreased to make the surface the conductor pattern precursor flat, thereby forming efficiently a conductor pattern with high reliability that is prevented from suffering cracking, breakage of wiring or the like.

According to another aspect of the invention, there is provided a method for forming a conductor pattern, including:

forming a bitmap data expressing a bitmap containing plural pixels disposed in matrix form based on a design data of a conductor pattern having a pad part and a wiring part connected to the pad part;

forming a conductor pattern precursor by ejecting liquid droplets of a conductor pattern forming ink by a liquid droplet ejecting method onto a substrate based on the bitmap data, and drying the liquid droplets, thereby forming a precursor of the conductor pattern on the substrate; and

firing the precursor, thereby forming the conductor pattern,

wherein in the formation of the bitmap data, the pixels are disposed in such a manner that clusters of the pixels corresponding to positions where the liquid droplets of the conductor pattern forming ink are attached form plural concentric annular shapes within a portion of the bitmap corresponding to the pad part.

According to the aspect, the difference in thickness between the portion corresponding to the pad part and the portion corresponding to the wiring part of the conductor pattern precursor can be decreased to make the surface the conductor pattern precursor flat, thereby forming efficiently a conductor pattern with high reliability that is prevented from suffering cracking, breakage of wiring or the like.

It is preferred in the method for forming a conductor pattern of the aspect that a pitch of the pixels is ½ or less (provided that 0 is excluded) of a diameter of the liquid droplet of the conductor pattern forming ink after reaching the substrate.

According to this configuration, a conductor pattern with high reliability can be formed.

It is preferred in the method for forming a conductor pattern of the aspect that in the portion of the bitmap corresponding to the pad part, a ratio of an area occupied by the clusters of the pixels corresponding to positions where the liquid droplets of the conductor pattern forming ink are attached is from 30 to 75%.

According to this configuration, the difference in thickness between the portion corresponding to the pad part and the portion corresponding to the wiring part of the conductor pattern precursor can be further decreased.

It is preferred in the method for forming a conductor pattern of the aspect that the plural annular shapes are spaced from each other.

According to this configuration, the difference in thickness between the portion corresponding to the pad part and the portion corresponding to the wiring part of the conductor pattern precursor can be further decreased.

It is preferred in the method for forming a conductor pattern of the aspect that in the liquid droplets of the conductor pattern forming ink attached to the substrate, a center distance of two liquid droplets that are adjacent to each other in the radial direction of the annular shapes is larger than a center distance of two liquid droplets that are adjacent to each other in the longitudinal direction of a line constituting the annular shapes.

According to this configuration, the difference in thickness between the portion corresponding to the pad part and the portion corresponding to the wiring part of the conductor pattern precursor can be further decreased.

It is preferred in the method for forming a conductor pattern of the aspect that the portion corresponding to the pad part of the precursor is formed continuously.

According to this configuration, a conductor pattern with high reliability can be formed.

It is preferred in the method for forming a conductor pattern of the aspect that the precursor has a value |a−b|/a of 0.3 or less (provided that 0 is included), wherein a represents a maximum value of a thickness of the portion corresponding to the pad part of the precursor, and b represents a maximum value of a thickness of the portion corresponding to the wiring part of the precursor.

According to this configuration, a conductor pattern can be prevented from suffering cracking, breakage of wiring or the like, and thus a conductor pattern with high reliability can be formed.

It is preferred in the method for forming a conductor pattern of the aspect that in the formation of the conductor pattern precursor, the liquid droplets of the conductor pattern forming ink are ejected onto the substrate from a liquid droplet ejecting head ejecting the liquid droplets of the conductor pattern forming ink, while moving relatively the liquid droplet ejecting head and the substrate,

in such a manner that in a first scanning, after the liquid droplets of the conductor pattern forming ink reach the substrate, two liquid droplets that are adjacent to each other are spaced from each other.

According to this configuration, the conductor pattern forming ink can be prevented from being concentrated locally on the substrate, whereby the difference in thickness between the portion corresponding to the pad part and the portion corresponding to the wiring part of the conductor pattern precursor can be further decreased.

It is preferred in the method for forming a conductor pattern of the aspect that the conductor pattern forming ink contains metal particles and a dispersion medium having the metal particles dispersed therein, and

in the formation of the conductor pattern precursor, the substrate is heated to a temperature that is higher than a temperature of the conductor pattern forming ink upon being ejected and is lower than a boiling point of the dispersion medium.

According to this configuration, the conductor pattern forming ink on the substrate can be quickly dried without bumping, and the conductor pattern forming ink can be prevented from being concentrated locally on the substrate, whereby the difference in thickness between the portion corresponding to the pad part and the portion corresponding to the wiring part of the conductor pattern precursor can be further decreased.

It is preferred in the method for forming a conductor pattern of the aspect that the substrate is a ceramic molded article constituted by a material containing a ceramic material and a binder, and

in the firing, the ceramic molded article and the precursor are fired to form the conductor pattern on a ceramic substrate.

According to this configuration, a conductor pattern with high reliability prevented from suffering cracking, breakage of wiring or the like can be formed on a ceramic substrate.

According to still another aspect of the invention, there is provided a wiring board including a conductor pattern that is produced by the method for forming a conductor pattern according to the aspect of the invention.

According to the aspect, a wiring board with high reliability having a conductor pattern with high reliability prevented from suffering cracking, breakage of wiring or the like can be provided.

According to yet another aspect of the invention, there is provided a liquid droplet ejecting apparatus including:

a table that supports a substrate;

a liquid droplet ejecting head that ejects liquid droplets of a conductor pattern forming ink to the substrate supported by the table;

a moving mechanism that moves relatively the table and the liquid droplet ejecting head; and

a controlling unit that controls operations of the liquid droplet ejecting head and the moving mechanism,

wherein upon forming a conductor pattern having a pad part and a wiring part connected to the pad part on the substrate, the controlling unit controls the operations of the liquid droplet ejecting head and the moving mechanism in such a manner that while moving relatively the table and the liquid droplet ejecting head with the moving mechanism, the liquid droplets of the conductor pattern forming ink are ejected from the liquid droplet ejecting head in such a manner that positions where the liquid droplets of the conductor pattern forming ink are attached form plural concentric annular shapes within a pad forming region where the pad part is to be formed on the substrate.

According to the aspect, a liquid droplet ejecting apparatus that is favorably used for forming a conductor pattern with high reliability prevented from suffering cracking, breakage of wiring or the like can be provided.

According to still yet another aspect of the invention, there is provided a liquid droplet ejecting apparatus including:

a table that supports a substrate;

a liquid droplet ejecting head that ejects liquid droplets of a conductor pattern forming ink to the substrate supported by the table;

a moving mechanism that moves relatively the table and the liquid droplet ejecting head;

a bitmap data forming unit that forms a bitmap data expressing a bitmap containing plural pixels disposed in matrix form based on a design data of a conductor pattern having a pad part and a wiring part connected to the pad part; and

a controlling unit that controls operations of the liquid droplet ejecting head and the moving mechanism,

wherein the bitmap data forming unit disposes the pixels in such a manner that clusters of the pixels corresponding to positions where the liquid droplets of the conductor pattern forming ink are attached form plural concentric annular shapes within a portion of the bitmap corresponding to the pad part, and

the controlling unit controls based on the bitmap data the operations of the liquid droplet ejecting head and the moving mechanism in such a manner that the liquid droplets of the conductor pattern forming ink are ejected onto the substrate from the liquid droplet ejecting head while moving relatively the table and the liquid droplet ejecting head with the moving mechanism.

According to the aspect, a liquid droplet ejecting apparatus that is favorably used for forming a conductor pattern with high reliability prevented from suffering cracking, breakage of wiring or the like can be provided.

### BRIEF DESCRIPTION OF THE DRAWINGS

The invention will be described with reference to the accompanying drawings, wherein like numbers reference like elements.

FIG. 1 is a cross sectional view showing an example of a structure of a wiring board (ceramics circuit board) according to an embodiment of the invention.

FIG. 2 is a perspective view showing a schematic structure of an embodiment of an ink-jet apparatus (liquid droplet ejecting apparatus) according to the invention.

FIG. 3 is a schematic illustration showing a schematic structure of an ink-jet head (liquid droplet ejecting head) of the ink-jet apparatus shown in FIG. 2.

FIG. 4 is a schematic illustration showing an example of a production method of the wiring board (ceramics circuit board) shown in FIG. 1.

FIGS. 5A and 5B are illustrations showing an example of process steps of a production method of the wiring board (ceramics circuit board) shown in FIG. 1.

FIG. 6 is a flow chart showing an embodiment of a method for forming a conductor pattern according to the invention (for showing a control operation of the ink-jet apparatus shown in FIG. 2).

FIG. 7 is an illustration showing an example of a structure of a conductor pattern.

FIG. 8 is an illustration showing an example of a structure of a conductor pattern precursor.

FIG. 9 is a schematic illustration showing an example of a structure of a bitmap.

FIG. 10 is an illustration showing an example of divided drawing.

FIG. 11 is an illustration showing an example of divided drawing.

### DESCRIPTION OF EXEMPLARY EMBODIMENTS

Preferred exemplary embodiments of the invention will be described in detail.

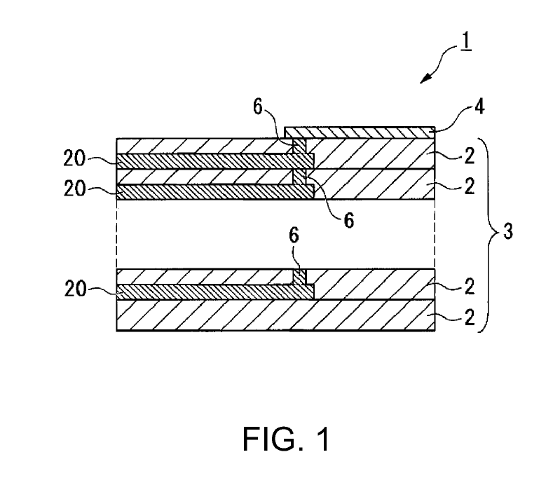

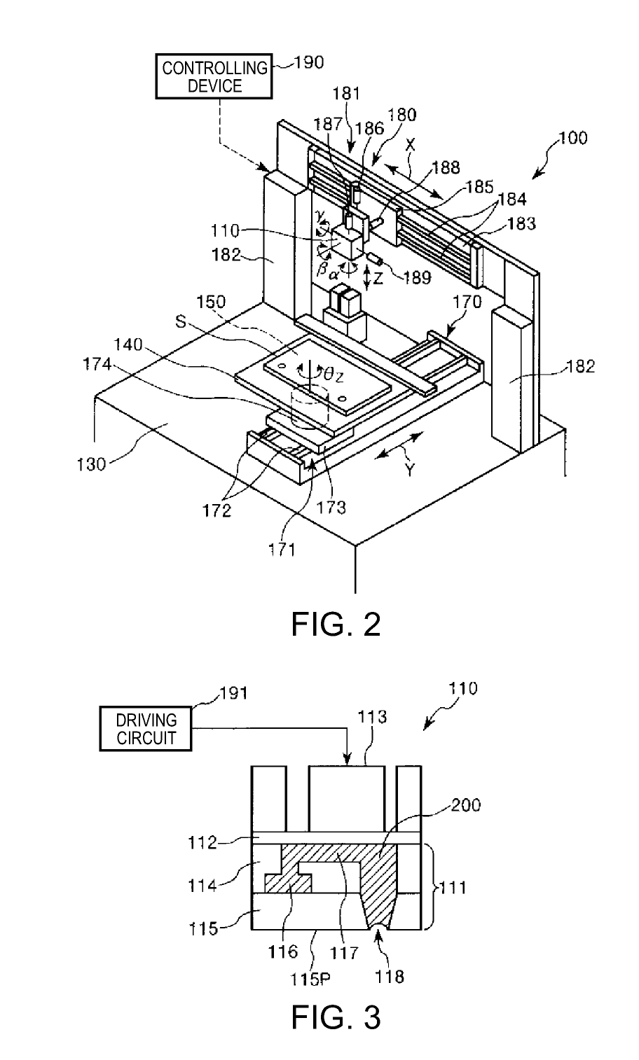

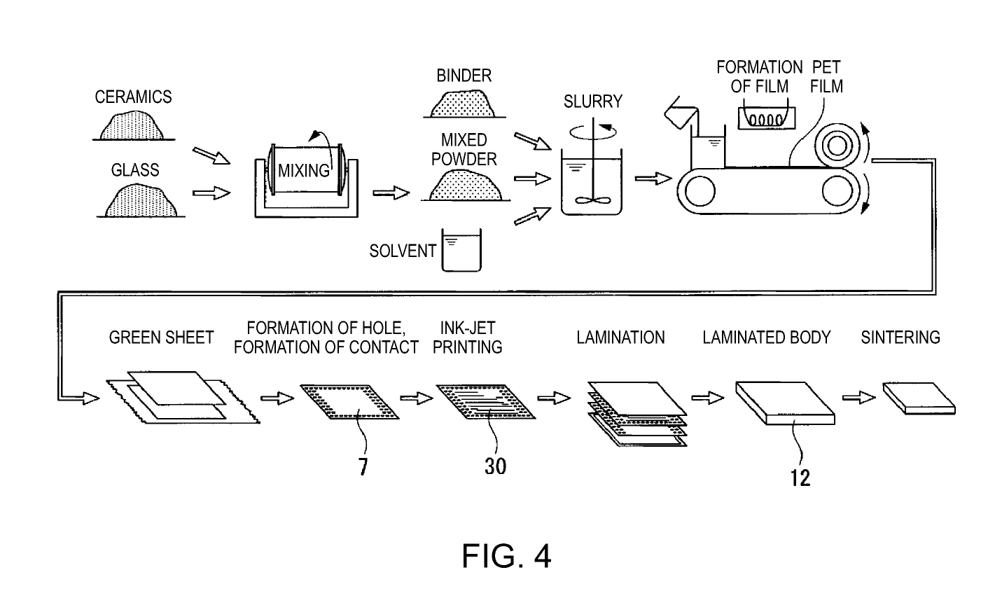

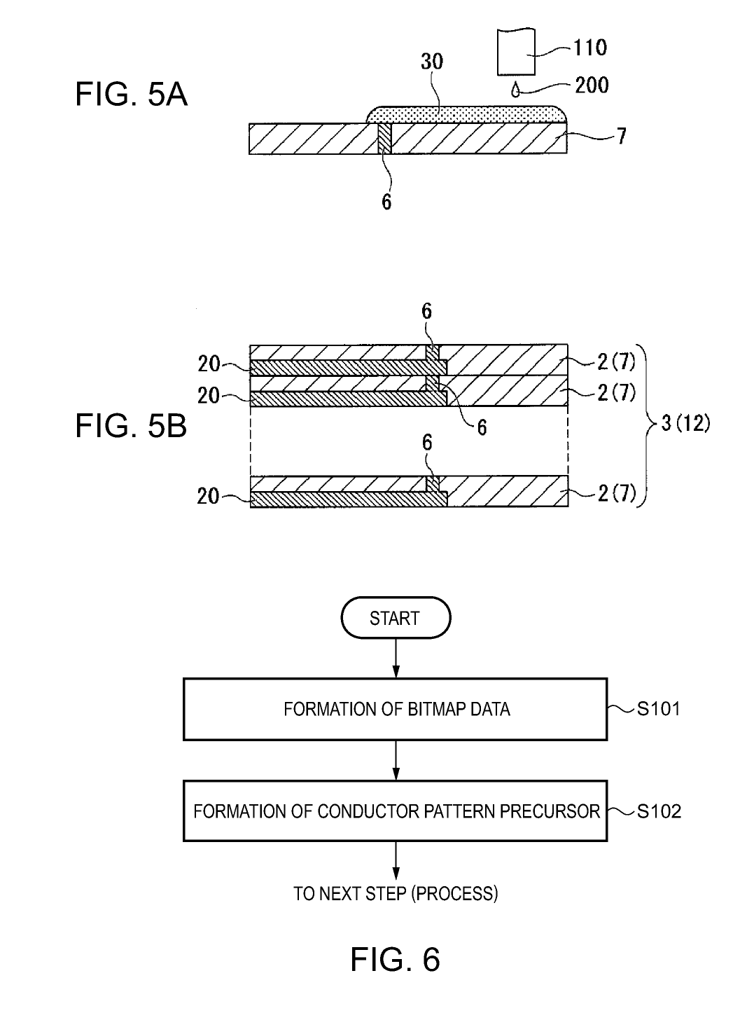

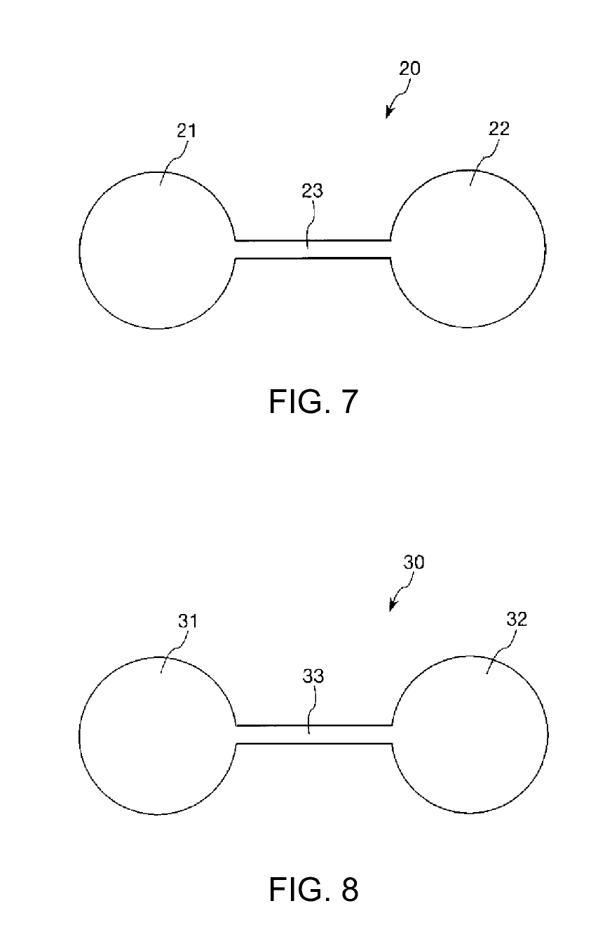

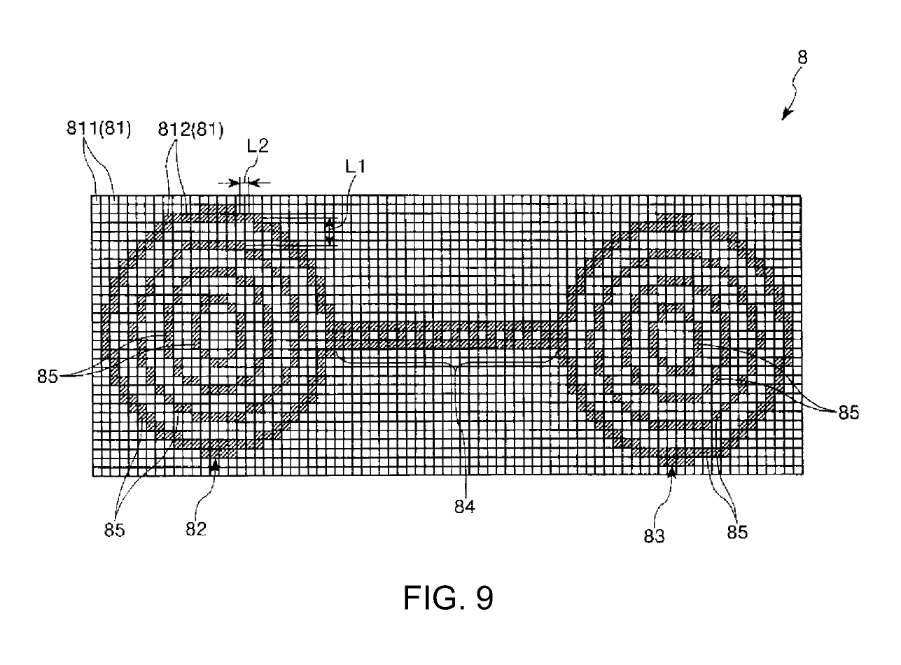

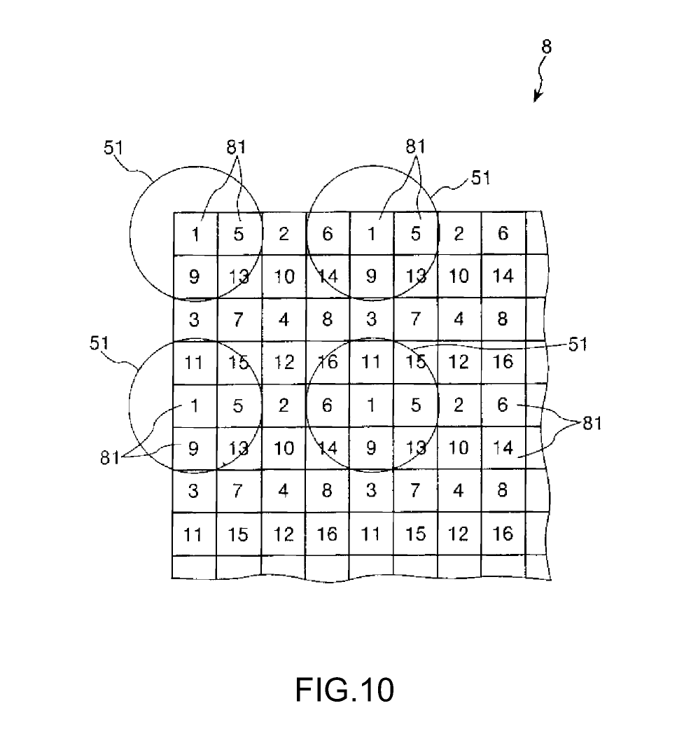

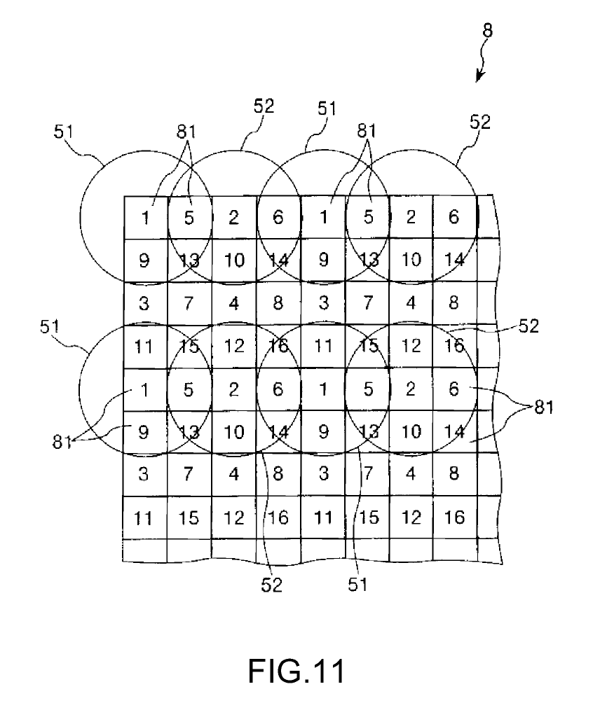

FIG. 1 is a cross sectional view showing an example of a structure of a wiring board (ceramics circuit board) according to an embodiment of the invention. FIG. 2 is a perspective view showing a schematic structure of an embodiment of an ink-jet apparatus (liquid droplet ejecting apparatus) according to an embodiment of the invention. FIG. 3 is a schematic illustration showing a schematic structure of an ink-jet head (liquid droplet ejecting head) of the ink-jet apparatus shown in FIG. 2. FIG. 4 is an illustration showing an example of a production method of the wiring board (ceramics circuit board) shown in FIG. 1. FIGS. 5A and 5B are illustrations showing an example of process steps of a production method of the wiring board (ceramics circuit board) shown in FIG. 1. FIG. 6 is a flow chart showing an embodiment of a method for forming a conductor pattern according to an embodiment of the invention (for showing a control operation of the ink-jet apparatus shown in FIG. 2). FIG. 7 is an illustration showing an example of a structure of a conductor pattern. FIG. 8 is an illustration showing an example of a structure of a conductor pattern precursor. FIG. 9 is a schematic illustration showing an example of a structure of a bitmap. FIG. 10 is an illustration showing an example of divided drawing. FIG. 11 is an illustration showing an example of divided drawing.

The method for forming a conductor pattern and the method for producing a wiring board according to the embodiment each include: formation of a bitmap data for forming a bitmap data expressing a bitmap based on a design data of a conductor pattern (wiring pattern); formation of a conductor pattern precursor for forming a conductor pattern precursor by ejecting liquid droplets of a conductor pattern forming ink by a liquid droplet ejecting method onto a substrate based on the bitmap data, and drying the liquid droplets, thereby forming a precursor of the conductor pattern on the substrate; and firing the precursor, thereby forming the conductor pattern.

The conductor pattern forming ink (which may be hereinafter referred simply to an ink) will be described.

### Conductor Pattern Forming Ink

The conductor pattern forming ink is an ink for forming a precursor of a conductor pattern (which may be hereinafter referred to as a conductor pattern precursor) by a liquid droplet ejecting method.

In this embodiment, the case where a conductor pattern forming ink 200 is a dispersion liquid containing silver particles as metal particles dispersed in an aqueous dispersion medium is described as a representative example.

Constitutional components of the conductor pattern forming ink 200 will be described in detail below.

### Aqueous Dispersion Medium

In this embodiment, the conductor pattern forming ink 200 contains an aqueous dispersion medium.

The aqueous dispersion medium referred in the embodiment is constituted by water and/or a liquid that is excellent in compatibility with water (for example, a liquid having a solubility of 30 g or more with respect to 100 g of water at 25° C.). The aqueous dispersion medium is constituted by water and/or a liquid excellent in compatibility with water, and preferably constituted mainly by water, and in particular, the aqueous dispersion medium preferably has a water content of 70% by weight or more, and more preferably 90% by weight or more. According to the constitution, the advantages are conspicuously exhibited.

Specific examples of the aqueous dispersion medium include water, an alcohol solvent, such as methanol, ethanol, butanol, propanol and isopropanol, an ether solvent, such as 1,4-dioxane and tetrahydrofuran (THF), an aromatic heterocyclic compound solvent, such as pyridine, pyrazine and pyrrole, an amide solvent, such as N,N-dimethylformamide (DMF) and N,N-dimethylacetamide (DMA), a nitrile solvent, such as acetonitrile, and an aldehyde solvent, such as acetaldehyde, and one kind or a combination of two or more kinds among these may be used.

The content of the aqueous dispersion medium in the conductor pattern forming ink 200 is preferably from 25 to 70% by weight, and more preferably from 30 to 60% by weight. According to the constitution, the ink 200 has a suitable viscosity and is prevented from suffering fluctuations in viscosity due to evaporation of the dispersion medium.

### Silver Particles

Silver particles (metal particles) will be described.

The silver particles constitute a major component of a conductor pattern 20 to be formed and impart electroconductivity to the conductor pattern 20.

The silver particles are dispersed in the ink.

The average particle diameter of the silver particles is preferably from 1 to 100 nm, and more preferably from 10 to 30 nm. According to the constitution, the ejection stability of the ink can be enhanced, and formation of a fine conductor pattern is facilitated. The average particle diameter referred herein means an average particle diameter based on volume unless otherwise indicated.

The average interparticle distance of the silver particles in the ink 200 is preferably from 1.7 to 380 nm, and more preferably from 1.75 to 300 nm. According to the constitution, the conductor pattern forming ink 200 has a further suitable viscosity and excellent ejection stability.

The content of the silver particles in the ink 200 (i.e., the silver particles (metal particles) having no dispersant adsorbed on the surface thereof) is preferably from 0.5 to 60% by weight, and more preferably from 10 to 45% by weight. According to the constitution, the conductor pattern 20 can be efficiently prevented from being broken, thereby providing the conductor pattern 20 with high reliability.

The silver particles (metal particles) are preferably dispersed in the aqueous dispersion medium in the form of silver colloid particles (metal colloid particles) having a dispersant attached to the surface thereof. According to the constitution, the silver particles have good dispersibility in the aqueous dispersion medium, and thus the ink 200 has excellent ejection stability.

The dispersant is not particularly limited, and preferably contains a hydroxy acid that has three or more in total of a COOH group and an OH group, in which the number of the COOH group is equal to or larger than the number of the OH group, or a salt of the hydroxy acid. The dispersant is adsorbed to the surface of the silver particles to form colloid particles, and the silver colloid particles are uniformly dispersed in an aqueous solution by the electric repulsive force of the COOH group present in the dispersant, thereby stabilizing the colloid solution. The silver colloid particles are stably present in the ink 200, thereby facilitating formation of a fine conductor pattern 20. Furthermore, the silver particles are distributed uniformly in a pattern formed with the ink 200 (i.e., a conductor pattern precursor 30), thereby preventing cracking, breakage of wiring or the like from occurring. In the case where the total number of the COOH group and the OH group is less than three or the number of the COOH group is less than the number of the OH group in the dispersant, on the other hand, sufficient dispersibility of the silver colloid particles may not be obtained in some cases.

Examples of the dispersant include citric acid, malic acid, trisodium citrate, tripotassium citrate, trilithium citrate, triammonium citrate, disodium malate, tannic acid, gallotannic acid and gallnut tannin, which may be used solely or as a combination of two or more of them.

The dispersant may contain a mercaptic acid having two or more in total of a COOH group and an SH group or a salt thereof. The mercapto group of the dispersant is adsorbed on the surface of the silver particles to form colloid particles, and the colloid particles are uniformly dispersed in an aqueous solution by the electric repulsive force of the COOH group present in the dispersant, thereby stabilizing the colloid solution. The silver colloid particles are stably present in the ink 200, thereby facilitating formation of a fine conductor pattern 20. Furthermore, the silver particles are distributed uniformly in a pattern formed with the ink 200 (i.e., a conductor pattern precursor 30), thereby preventing cracking, breakage of wiring or the like from occurring. In the case where the total number of the COOH group and the SH group is less than two in the dispersant, i.e., only one of them is present therein, on the other hand, sufficient dispersibility of the silver colloid particles may not be obtained in some cases.

Examples of the dispersant include mercaptoacetic acid, mercaptopropionic acid, thiodipropionic acid, mercaptosuccinic acid, thioacetic acid, sodium mercaptoacetate, sodium mercaptopropionate, sodium thiodipropionate, disodium mercaptosuccinate, potassium mercaptoacetate, potassium mercaptopropionate, potassium thiodipropionate and dipotassiummercaptosuccinate, which may be used solely or as a combination of two or more of them.

The content of the silver colloid particles in the ink 200 is preferably from 1 to 60% by weight, and more preferably from 5 to 50% by weight. When the content of the silver colloid particles is less than the lower limit, the content of silver is too small, and thus the ink is necessarily coated plural times when a relatively thick film is to be formed for forming the conductor pattern 20. When the content of the silver colloid particles exceeds the upper limit, the content of silver is too large, and thus the ink is necessarily agitated frequently for preventing aggregation due to the low dispersibility.

The weight loss on heating to 500° C. in thermogravimetric analysis of the silver colloid particles is preferably from 1 to 25% by weight. When the colloid particles (solid content) is heated to 500° C., the dispersant attached to the surface thereof, the reducing agent (remaining reducing agent) described later, and the like are oxidized and decomposed, and most of them disappear through gasification. It is considered that the amount of the remaining reducing agent is only a slight amount, and thus the weight loss on heating to 500° C. substantially corresponds to the amount of the dispersant in the silver colloid particles. When the weight loss on heating is less than 1% by weight, the amount of the dispersant with respect to the silver particles is too small, and thus the dispersibility of the silver particles is impaired. When the weight loss exceeds 25% by weight, the amount of the remaining dispersant with respect to the silver particles is too large, and thus the specific resistance of the conductor pattern is increased. The specific resistance can be improved to some extent by decomposing and eliminating the organic content through sintering by heating after forming the conductor pattern 20. Therefore, the operation is effective for a ceramic substrate or the like that is sintered at a higher temperature.

### Organic Binder

The conductor pattern forming ink 200 may contain an organic binder. The organic binder prevents the silver particles from being aggregated in the conductor pattern precursor 30 formed with the conductor pattern forming ink 200. Specifically, in the conductor pattern precursor 30 thus formed, the organic binder intervenes between the silver particles, thereby preventing formation of cracking in a part of the pattern due to aggregation of the silver particles. The organic binder can be removed by decomposition on firing, and the silver particles in the conductor pattern precursor 30 are bound to form the conductor pattern 20.

When the conductor pattern forming ink 200 contains the organic binder, the adhesion of the conductor pattern precursor 30 to a ceramic molded article 7 can be particularly enhanced, thereby preventing the metal particles constituting the conductor pattern precursor 30 from outflowing to an unintended portion. Consequently, cracking, breakage of wiring, short circuit or the like can be effectively prevented from occurring, thereby forming the conductor pattern 20 with high accuracy, and thus the reliability of the conductor pattern 20 finally obtained can be particularly enhanced.

The organic binder is not particularly limited, and examples thereof include polyethylene glycol, such as polyethylene glycol #200 (weight average molecular weight: 200), polyethylene glycol #300 (weight average molecular weight: 300), polyethylene glycol #400 (weight average molecular weight: 400), polyethylene glycol #600 (weight average molecular weight: 600), polyethylene glycol #1000 (weight average molecular weight: 1,000), polyethylene glycol #1500 (weight average molecular weight: 1,500), polyethylene glycol #1540 (weight average molecular weight: 1,540) and polyethylene glycol #2000 (weight average molecular weight: 2,000), polyvinyl alcohol, such as polyvinyl alcohol #200 (weight average molecular weight: 200), polyvinyl alcohol #300 (weight average molecular weight: 300), polyvinyl alcohol #400 (weight average molecular weight: 400), polyvinyl alcohol #600 (weight average molecular weight: 600), polyvinyl alcohol #1000 (weight average molecular weight: 1,000), polyvinyl alcohol #1500 (weight average molecular weight: 1,500), polyvinyl alcohol #1540 (weight average molecular weight: 1,540) and polyvinyl alcohol #2000 (weight average molecular weight: 2,000), and a polyglycerin compound having a polyglycerin skeleton, such as polyglycerin and a polyglycerin ester, which may be used solely or as a combination of two or more of them. Examples of the polyglycerin ester include monostearate, tristearate, tetrastearate, monooleate, pentaoleate, monolaurate, monocaprylate, polysinolate, sesquistearate, decaoleate and sesquioleate of polyglycerin.

In the case where the polyglycerin compound among these is used as the organic binder, the following effect can be obtained.

Upon drying the conductor pattern precursor 30 formed with the conductor pattern forming ink 200 (i.e., upon removal of the dispersion medium), the polyglycerin compound can favorably prevent cracking from occurring in the conductor pattern precursor 30. It is considered that the effect is obtained because of the following mechanism. When the polyglycerin compound is contained in the conductor pattern forming ink 200, polymer chains are present among the silver particles (metal particles), and the polyglycerin compound controls suitably the distance between the silver particles. Furthermore, the polyglycerin compound is not removed upon removing the aqueous dispersion medium owing to the relatively high boiling point thereof, and is attached to the circumference of the silver particles. Accordingly, the state where the silver particles are encompassed with the polyglycerin compound is continued for a prolonged period of time upon removing the aqueous dispersion medium, whereby rapid decrease in volume due to evaporation of the aqueous dispersion medium can be prevented, and the silver particles can be prevented from suffering particle growth (aggregation). As a result, the conductor pattern precursor 30 can be prevented from suffering cracking.

The polyglycerin compound certainly prevents breakage of wiring from occurring upon firing for forming the conductor pattern 20. It is considered that the effect is obtained because of the following mechanism. The polyglycerin compound has a relatively high boiling point or decomposition temperature. Accordingly, in the course of process for forming the conductor pattern 20 from the conductor pattern precursor 30, the polyglycerin compound can be present in the conductor pattern precursor 30 without evaporation or thermal (oxidation) decomposition until reaching a relatively high temperature after evaporation of the aqueous dispersion medium. The polyglycerin compound is present around the silver particles until the polyglycerin compound is evaporated or thermally (oxidatively) decomposed, thereby preventing proximity and aggregation of the silver particles, and after the polyglycerin compound is decomposed, the silver particles are bound uniformly. Furthermore, the polymer chains (i.e., the polyglycerin compound) are present among the silver particles (metal particles) in the pattern upon firing, whereby the polyglycerin compound maintains the distance between the silver particles. The polyglycerin compound has suitable flowability. Accordingly, the polyglycerin compound contained in the conductor pattern precursor 30 enhances the followability of the conductor pattern precursor 30 to expansion and contraction of the ceramic molded article 7 due to temperature change.

It is considered that breakage of wiring in the conductor pattern 20 thus formed can be effectively prevented from occurring owing to the aforementioned mechanisms.

The polyglycerin compound contained makes the ink 200 to have a suitable viscosity, whereby the ejection stability thereof from the ink-jet head 110 can be effectively enhanced, and the film forming property thereof can also be enhanced.

As the polyglycerin compound, polyglycerin among the compound mentioned above is preferably used. Polyglycerin is particularly excellent in enhancement of the followability to expansion and contraction of the ceramic molded article 7 due to temperature change, and after sintering the ceramic molded article 7, can be certainly removed from the conductor pattern 20. Consequently, the conductor pattern 20 has enhanced electric characteristics. Furthermore, polyglycerin has high solubility in the aqueous dispersion medium and thus can be used favorably.

The organic binder preferably has a weight average molecular weight of from 300 to 3,000, more preferably from 400 to 1,000, and further preferably from 400 to 600. According to the constitution, formation of cracking can be certainly prevented from occurring upon drying the pattern formed with the conductor pattern forming ink 200. When the weight average molecular weight of the organic binder is less than the lower limit, on the other hand, the organic binder tends to be decomposed upon removing the aqueous dispersion medium while depending on the composition of the organic binder, and thus the effect of preventing formation of cracking may be diminished. When the weight average molecular weight of the organic binder exceeds the upper limit, the solubility and dispersibility in the ink 200 may be decreased owing to the excluded volume effect while depending on the composition of the organic binder.

The content of the organic binder in the ink 200 is preferably from 1 to 30% by weight, and more preferably from 5 to 20% by weight. According to the constitution, the ink 200 has excellent ejection stability, and simultaneously creaking and breakage of wiring can be effectively prevented from occurring. When the content of the organic binder is less than the lower limit, on the other hand, the effect of preventing cracking may be diminished in some cases while depending on the composition of the organic binder. When the content of the organic binder exceeds the upper limit, the viscosity of the ink 200 cannot be sufficiently lowered in some cases while depending on the composition of the organic binder.

### Drying Inhibitor

The conductor pattern forming ink 200 may contain a drying inhibitor. The drying inhibitor inhibits unintended evaporation of the aqueous dispersion medium in the ink 200. Accordingly, evaporation of the aqueous dispersion medium can be inhibited in the vicinity of the ejection part of the ink-jet apparatus, and thus the ink 200 can be prevented from suffering increase in viscosity and drying. The drying inhibitor contained in the conductor pattern forming ink 200 particularly enhances the ejection stability of liquid droplets of the ink 200. Specifically, the liquid droplets of the ink 200 have less fluctuation in weight and are prevented from suffering clogging, deviation on flying and the like. Furthermore, even in the case where the conductor pattern forming ink 200 is charged to the ink-jet apparatus, and the ink-jet apparatus is then maintained for a prolonged period of time (for example, for five days) without operation, the conductor pattern forming ink 200 can be ejected at a constant amount to an intended position with high accuracy.

Examples of the drying inhibitor include the compound represented by the following formula (I), an alkanolamine and a sugar alcohol, which may be used solely or as a combination of two or more of them.

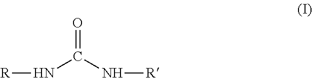

wherein R and R′ each represent H or alkyl.

The compound represented by the formula (I) has high hydrogen bond-forming property. Accordingly, the compound retains suitable water content owing to the high hydrophilicity thereof, and thus unintended evaporation of the aqueous dispersion medium of the conductor pattern forming ink 200 can be prevented from occurring.

The compound is relatively combustible and thus can be easily removed (oxidation and decomposition) from the conductor pattern 20 upon forming the conductor pattern 20.

In the case where the metal particles (silver particles) are colloid particles having the dispersant attached to the surface thereof, the compound has a function of enhancing the dispersion stability of the metal particles through hydrogen bond to the dispersant present on the surface. Accordingly, the conductor pattern forming ink 200 has excellent ejection stability and excellent storage stability.

R and R′ in the compound represented by the formula (I) used in the embodiment of the invention each represent hydrogen or an alkyl group, and it is preferred that both R and R′ are hydrogen, i.e., urea. According to the constitution, the moisture retaining property can be further enhanced, thereby providing particularly excellent ejection stability. The excellent ejection stability is particularly exhibited in the case where the metal particles are present as colloid particles as described above.

The content of the compound represented by the formula (I) in the ink is preferably from 5 to 25% by weight, more preferably from 8 to 20% by weight, and further preferably from 10 to 18% by weight. According to the constitution, unintended drying of the conductor pattern forming ink 200 can be effectively prevented from occurring. As a result, the ink 200 has particularly excellent ejection stability.

The alkanolamine has high moisture retaining property, and in the case where the metal particles are colloid particles, can activate the functional groups of the dispersant present on the surface of the colloid particles, thereby further enhancing the dispersion stability of the metal particles.

Examples of the alkanolamine include monoethanolamine, diethanolamine, triethanolamine, monopropanolamine, dipropanolamine and tripropanolamine.

The alkanolamine is preferably a tertiary amine. The tertiary amine among the alkanolamine has particularly high moisture retaining property and provides the aforementioned effect conspicuously.

The tertiary amine is preferably triethanolamine from the standpoint of handleability and high moisture retaining property.

The content of the alkanolamine in the conductor pattern forming ink 200 is preferably from 1 to 10% by weight, and more preferably from 3 to 7% by weight. According to the constitution, the ejection stability of the conductor pattern forming ink 200 can be particularly enhanced.

The sugar alcohol is obtained by reducing an aldehyde group and a ketone group of a sugar compound.

The sugar alcohol has high moisture retaining property. The sugar alcohol is easily decomposed and removed upon reaching the decomposition temperature of the sugar alcohol owing to the large number of oxygen atoms per molecule. Accordingly, upon forming the conductor pattern 20, the sugar alcohol can be removed (oxidation and decomposition) from the conductor pattern 20 by making the temperature of the conductor pattern precursor 30 higher than the decomposition temperature of the sugar alcohol.

Examples of the sugar alcohol include threitol, erythritol, pentaerythritol, dipentaerythritol, tripentaerythritol, arabitol, ribitol, xylitol, sorbitol, mannitol, threitol, gulitol, talitol, galactitol, allitol, altritol, dulcitol, iditol, glycerin (glycerol), inositol, maltitol, isomaltitol, lactitol and turanitol, which may be used solely or as a combination of two or more of them.

The content of the sugar alcohol in the conductor pattern forming ink 200 is preferably from 3 to 20% by weight, and more preferably from 5 to 15% by weight. According to the constitution, evaporation of the aqueous dispersion medium in the conductor pattern forming ink 200 can be certainly inhibited, whereby the conductor pattern forming ink 200 has particularly excellent ejection stability of liquid droplets thereof for a prolonged period of time.

### Surface Tension Controlling Agent

The conductor pattern forming ink 200 may contain a surface tension controlling agent.

The surface tension controlling agent has a function of controlling the contact angle between the conductor pattern forming ink 200 and the ceramic molded article 7 to an intended angle.

Examples of the surface tension controlling agent include various kinds surfactants, which may be used solely or as a combination of two or more of them, and the surface tension controlling agent preferably contains an acetylene glycol compound.

The acetylene glycol compound can control the contact angle between the conductor pattern forming ink 200 and the ceramic molded article 7 to an intended range with a small amount added. The contact angle between the conductor pattern forming ink 200 and the ceramic molded article 7 is controlled to an intended range, thereby forming a fine conductor pattern 20. Furthermore, even in the case where bubbles are entrained into the liquid droplets thus ejected, the bubbles can be removed quickly. Consequently, the conductor pattern 20 thus formed can be effectively prevented from suffering cracking, breakage of wiring or the like.

Examples of the acetylene glycol compound include Surfynol 104 Series (e.g., 104E, 104H, 104PG-50 and 104PA), Surfynol 400 Series (e.g., 420, 465 and 485) and Olfine Series (e.g., EXP4036, EXP4001 and E1010) (Surfynol and Olfine are trade names by Nisshin Chemical Industry Co., Ltd.), which may be used solely or as a combination of two or more of them.

The ink 200 preferably contains two or more kinds of acetylene glycol compounds that are different in HLB value, whereby the contact angle between the conductor pattern forming ink 200 and the ceramic molded article 7 can be easily controlled to an intended range.

In particular, among two or more kinds of the acetylene glycol compounds that are different in HLB value and contained in the ink 200, the difference between the HLB value of the acetylene glycol compound that has the highest HLB value and the HLB value of the acetylene glycol compound that has the lowest HLB value is preferably from 4 to 12, and more preferably from 5 to 10. According to the constitution, the contact angle between the conductor pattern forming ink 200 and the ceramic molded article 7 can be further easily controlled to an intended range with a small amount of the acetylene glycol compounds added.

In the case where two or more kinds of the acetylene glycol compounds are used in the ink 200, the HLB value of the acetylene glycol compound that has the highest HLB value is preferably from 8 to 16, and more preferably from 9 to 14.

In the case where two or more kinds of the acetylene glycol compounds are used in the ink 200, the HLB value of the acetylene glycol compound that has the lowest HLB value is preferably from 2 to 7, and more preferably from 3 to 5.

The content of the surface tension controlling agent contained in the ink 200 is preferably from 0.001 to 1% by weight, and more preferably from 0.01 to 0.5% by weight. According to the constitution, the contact angle between the conductor pattern forming ink 200 and the ceramic molded article 7 can be effectively controlled to an intended range.

### Other Components

The constitutional components of the conductor pattern forming ink 200 are not limited to the components mentioned above, and may contain other components than above.

Examples of the other components include a moisture retaining agent, such as thiourea, trimethylolpropane 2-pyrrolidinone, a pH controlling agent, such as triethylamine and trimethylamine, and other additives, such as an antiseptic and a fungicide.

The viscosity of the conductor pattern forming ink 200 is not particularly limited and is preferably from 1 to 25 mPa·s, and more preferably from 3 to 25 mPa·s. According to the constitution, excellent ejection property of the liquid droplets can be obtained, and the ink 200 reaching the ceramic molded article 7 can be prevented from spreading unintendedly, thereby providing the conductor pattern precursor 30 having a fine line width.

### Ink-jet Apparatus

An ink-jet apparatus (liquid droplet ejecting apparatus) 100 according to the embodiment will be described.

In this embodiment, the conductor pattern forming ink 200 mentioned above can be ejected, for example, by using an ink-jet apparatus (liquid droplet ejecting apparatus) 100 shown in FIGS. 2 and 3. The ink-jet apparatus 100 and ejection of liquid droplets by using the ink-jet apparatus 100 will be described.

In FIG. 2, the X-axis is the crosswise direction of a base 130, the Y-axis is the machine direction thereof, and the Z-axis is the vertical direction thereof.

The ink-jet apparatus 100 is an apparatus that ejects liquid droplets of an ink by an ink-jet method. The ink-jet apparatus 100 has an ink-jet head (i.e., a liquid droplet ejecting head, which may be hereinafter referred simply to a head) 110 shown in FIG. 3 that ejects liquid droplets of the ink 200, a base 130, a table 140, a controlling device (controlling unit) 190, a table positioning unit 170 and a head positioning unit 180. The ink-jet apparatus 100 generally has a head unit that contains plural ink-jet heads 110, but herein the case where the apparatus has a single ink-jet head 110 is described as a representative example.

The base 130 is a platform that supports the constitutional members of the liquid droplet ejecting apparatus 100, such as the table 140, the table positioning unit 170 and the head positioning unit 180.

The table 140 is placed on the base 130 through the table positioning unit 170. The table 140 supports a substrate S (which is a ceramics green sheet 7 in this embodiment).

A rubber heater (heating unit) 150 that heats the ceramics green sheet 7 is placed on the back surface of the table 140. The ceramics green sheet 7 placed on the table 140 is heated to a prescribed temperature by the rubber heater 150, which heats the entire upper surface of the ceramics green sheet 7.

The table positioning unit 170 has a first moving unit 171 and a motor 174. The table positioning unit 170 determines the position in the Y-axis direction (i.e., the horizontal direction that is perpendicular to the X-axis direction) and the rotational position in the θz direction (i.e., the direction around the Z-axis) of the table 140 on the base 130, whereby determining the position in the Y-axis direction and the rotational position in the θz direction of the ceramics green sheet 7.

The first moving unit 171 has two rails 172 provided in the Y-axis direction, a pedestal 173 mounted movably along the rails 172, and a motor (which is not shown in the figure). The pedestal 173 supports the table 140 through a motor 174.

The pedestal 173 is moved along the rails 172 by driving with the motor of the first moving unit 171, and the table 140 supporting the substrate S is moved and positioned in the Y-axis direction.

The motor 174 supports the table 140, and the table 140 is swung and positioned in the θz direction by driving with the motor 174.

The head positioning unit 180 has a second moving unit 181, a linear motor (i.e., a third moving unit) 186 and motors 187, 188 and 189. The head positioning unit 180 determines the positions of the head 110 in the Y-axis direction and the Z-axis direction (which is the direction that is perpendicular to the X-axis direction and the Y-axis direction, i.e., the vertical direction).

The second moving unit 181 has two supporting columns 182 set up on the base 130, a rail base 183 having two rails 184 that are supported between the two supporting columns 182 and provided in the X-axis direction (i.e., one horizontal direction), a supporting member 185 provided movably along the rails 184, and a motor (which is not shown in the figure). The supporting member 185 supports the head 110 through the linear motor 186.

The supporting member 185 is moved along the rails 184 by driving with the motor of the second moving unit 181, and the linear motor 186 and the head 110 are moved and positioned in the X-axis direction.

The linear motor 186 supports the head 110, and the head 110 is moved and positioned in the Z-axis direction by driving with the linear motor 186.

The head 110 is swung and positioned in the α direction (i.e., the direction around the Z-axis), the β direction (i.e., the direction around the Y-axis) and the γ direction (i.e., the direction around the X-axis) by driving with the motors 187, 188 and 189, respectively.

The ink-jet apparatus 100 can accurately control the relative positions and postures of an ink ejection plane 115P of the head 110 and the substrate S on the table 140 with the table positioning unit 170 and the head positioning unit 180. The first moving unit 171 and the second moving unit 181 constitute the moving mechanism (moving unit) that relatively moves the table 140 and the head 110.

As shown in FIG. 3, the head 110 ejects the ink 200 from a nozzle (ejecting part) 118 by an ink-jet method (liquid droplet ejecting method). Liquid droplets of the ink 200 are ejected from the nozzle 118 of the head 110 toward the substrate S placed on the table 140 and are attached to (reach) the substrate S. In this embodiment, the head 110 employs a piezoelectric system where the ink 200 is ejected with a piezoelectric device 113. The piezoelectric system has such advantages that the composition of the materials is not influenced thereby since no heat is applied thereto.

The head 110 has a head body 111, a vibration plate 112 and a piezoelectric device 113.

The head body 111 has a main body 114 and a nozzle plate 115 attached to the lower end surface of the main body 114. The main body 114 is held by the nozzle plate 115 and the vibration plate 112, which are in the form of plate, thereby forming a reservoir 116 and plural ink chambers 117 branched from the reservoir 116, which are in the form of space.

The ink 200 is fed to the reservoir 116 from an ink tank (which is not shown in the figure). The reservoir 116 forms flow paths for feeding the ink 200 to the ink chambers 117.

The nozzle plate 115 is attached to the lower end surface of the main body 114 to constitute the ink ejection plane 115P. The nozzle plate 115 has formed therein plural nozzles 118 for ejecting the ink 200 corresponding to the ink chambers 117, respectively. The ink flow paths are formed from the ink chambers 117 toward the nozzle 118 corresponding thereto, respectively.

The vibration plate 112 is attached to the upper end surface of the head body 111 and constitutes a wall of the ink chambers 117. The vibration plate 112 can be vibrated corresponding to vibration of the piezoelectric device 113.

The piezoelectric device 113 is provided on the opposite side of the vibration plate 112 to the head body 111, corresponding to the ink chambers 117. The piezoelectric device 113 contains a piezoelectric material, such as quartz, held with a pair of electrodes (which are not shown in the figure). The pair of electrodes are connected to a driving circuit 191.

Upon inputting an electric signal to the piezoelectric device 113 from the driving circuit 119, the piezoelectric device 113 is deformed by expansion or contraction. When the piezoelectric device 113 is deformed by contraction, the pressure in the ink chamber 117 is decreased, and the ink 200 flows into the ink chamber 117 from the reservoir 116. When the piezoelectric device 113 is deformed by expansion, the pressure in the ink chamber 117 is increased, and the ink 200 is ejected from the nozzle 118. The deformation amount of the piezoelectric device 113 can be controlled by changing the voltage applied thereto. The deformation velocity of the piezoelectric device 113 can be controlled by changing the frequency of the voltage applied thereto. Accordingly, the ejection conditions of the ink 200 can be controlled by controlling the voltage applied to the piezoelectric device 113.

The controlling device 190 controls the operations of the members constituting the ink-jet apparatus 100, such as the motor of the first moving unit 171, the motor 174, the motor of the second moving unit 181, the linear motor 186, the motors 187, 188 and 189, the rubber heater 150 and the driving circuit 191. As one example, the controlling device 190 controls, for example, the waveform of the application voltage generated by the driving circuit 191 for controlling the ejection conditions of the ink 200, and controls the operations of the head positioning unit 170 and the table positioning unit 180 for controlling the ejection position of the ink 200 to the substrate S. The controlling device 190 achieves the major functions of the bitmap data forming unit. The functions and the like of the bitmap data forming unit of the controlling device 190 will be described in detail later.

By using the ink-jet apparatus 100 described above, the ink 200 can be ejected onto the desired position on the ceramics green sheet 7 (substrate S) in a desired amount with high accuracy.

The conductor pattern, the method for forming a conductor pattern, a ceramics circuit board (wiring board) having a conductor pattern, and the method for producing the ceramics circuit board will be described.

As shown in FIG. 1, the ceramics circuit board (wiring board) 1 has a laminated substrate 3 containing a large number (for example, from 10 to 20 plies) of ceramics substrates 2 laminated on each other, and a circuit 4 containing a fine wiring and the like formed on the outermost surfaces, e.g., one surface or both surfaces, of the laminated substrate 3.

The laminated substrate 3 has circuits (conductor patterns) 20 formed with a conductor pattern forming ink between the ceramics substrate 2 and 2 laminated on each other.

The circuits 20 are equipped with a contact (via hole) 6 connected thereto. According to the structure, the circuits 20 and 20 provided adjacent thereto are electrically connected with the contact 6. The circuit 4 is also formed with a conductor pattern forming ink as similar to the circuits 20.

A method for producing the ceramics circuit board 1 will be described with reference to the schematic process illustration shown in FIG. 4. As raw material powder, ceramics powder containing alumina (Al₂O₃), titanium oxide (TiO₂) or the like having an average particle diameter of from 1 to 2 μm and glass powder containing borosilicate glass or the like having an average particle diameter of from 1 to 2 μm are prepared, and they are mixed at a suitable mixing ratio, for example, 1/1 by weight.

To the resulting mixed powder, a suitable binder, a plasticizer, an organic solvent (dispersant) and the like are added, and they are mixed and agitated to provide a slurry. The binder used herein is preferably polyvinyl butyral, which is insoluble in water and is dissolved or swelled in a so-called oily organic solvent.

The resulting slurry is then formed into a sheet on a PET film by using a doctor blade, a reverse coater or the like, and molded into a sheet having a thickness of from several micrometers to several hundred micrometers depending on the production conditions of the target product, which is then wound into a roll.

Subsequently, the sheet is cut depending on the purpose of the product, and shaped into the prescribed dimension. In this embodiment, the sheet is cut into a square shape having an edge length of 200 mm.

A through hole is formed at the prescribed position of the sheet by CO₂ laser, YAG laser, mechanical punching or the like. A thick film conductive paste having metal particles dispersed therein is filled in the through hole, thereby forming the portion to be the contact 6. The thick film conductive paste is coated by screen printing to form a terminal part (which is not shown in the figure) at the prescribed position. Accordingly, the contact 6 and the terminal part are formed to provide a ceramics green sheet (ceramics molded article) 7. The thick film conductive paste used herein may be the conductor pattern forming ink.

On one surface of the resulting ceramics green sheet (ceramics molded article) 7, a precursor of a conductor pattern (circuit) 20, i.e., a conductor pattern precursor, is formed to be connected to the contact. Specifically, as shown in FIG. 5A, the conductor pattern forming ink 200 is applied to the ceramics green sheet 7 by a liquid droplet ejecting method (ink-jet method) and then dried to form the conductor pattern precursor 30 to be the circuit 20.

As shown in FIG. 7, the conductor pattern (wiring pattern) 20 herein has at least one pad part and at least one wiring part connected to the pad part. In the structure shown in the figure, the conductor pattern 20 has pad parts 21 and 22 and a wiring part 23 connecting the pad part 21 and the pad part 22. The conductor pattern 20 is not limited thereto, and may have one pad part connected to plural wiring parts. The number of the pad part may be one and may be three or more.

The pad parts 21 and 22 each have a circular shape in plan view. The shapes of the pad parts 21 and 22 are not limited thereto, and may be, for example, an elliptical shape, a polygonal shape, such as square, or the like. The shape of the pad part 21 may be different from the shape of the pad part 22.

The wiring part 23 has a linear shape (strip shape) in plan view. The shape of the wiring part 23 is not limited thereto, and may be, for example, a curved shape, a kinked line shape or the like, or a shape formed by combining these shapes.

In this embodiment, the case where the conductor pattern 20 shown in the figure is formed is described as a representative example.

In this embodiment, the conductor pattern forming ink is ejected by using the ink-jet apparatus (liquid droplet ejecting apparatus) 100 shown in FIG. 2 and the ink-jet head (liquid droplet ejecting head) 110 shown in FIG. 3, based on a bitmap data.

### Formation of Bitmap Data

Preceding the formation of the conductor pattern precursor 30, a design data, such as a CAD data, of the conductor pattern 20 is input to the ink-jet apparatus 100, as shown in FIG. 6. The controlling device 190 of the ink-jet apparatus 100 forms a bitmap data expressing a bitmap 8 having plural pixels 81 disposed in matrix form shown in FIG. 9 based on the design data (Step S101).

In this embodiment, the pixels 81 of the bitmap 8 each have a square shape (a tetragonal shape), but the shape of the pixel is not limited thereto.

The pixels 81 of the bitmap 8 is constituted by first pixels 811 corresponding to positions where the ink droplets are attached (reaching) and second pixels 812 corresponding to positions where the ink droplets are not attached (reaching). “Corresponding to positions where the ink droplets are attached” does not means that the ink is finally attached to the positions, but means that the positions are targets for attaching the ink droplets. With respect to the pixels, hereinafter, when the first pixels 811 and the second pixels 812 are distinguished from each other, they are referred to as the first pixels 811 and the second pixels 812, and when they are not distinguished from each other but are referred generically, they are referred to as the pixels 81.

The pitch (center distance) of the pixels 81 is smaller than the diameter of the ink droplets after reaching the ceramics green sheet 7 as the substrate (provided that 0 is excluded), and may be determined depending on the conditions. Specifically, the pitch of the pixels 81 is preferably ½ or less of the diameter of the ink droplets after reaching the ceramics green sheet 7 (provided that 0 is excluded), and more preferably ⅓ or less thereof. According to the constitution, the ink droplets ejected by the single ejection operation is spread and attached to the positions corresponding to the plural pixels 81, whereby the position to be attached with the ink can be prevented from not being attached with the ink, thereby providing the conductor pattern 20 with high reliability.

In the portion 84 corresponding to the wiring part 23 in the bitmap 8, the first pixels 811 and the second pixels 812 may be disposed in any pattern, and only the first pixels 811 may be disposed. The ratio of the area occupied by the first pixels 811 and the area occupied by the second pixels 812 in the portion 84 may be controlled for controlling the thickness or the like of the wiring part 23. The ratio of the area occupied by the first pixels 811 and the area occupied by the second pixels 812 is equal to the ratio of the number of the first pixels 811 and the number of the second pixels 812.

In the portions 82 and 83 corresponding to the pad parts 21 and 22 of the bitmap 8, respectively, the first pixels 811 are disposed in such a manner that the clusters of the first pixels 811 form plural concentric annular shapes. In this embodiment, the annular shapes 85 each have a circular shape, and concentric circles are formed with the annular shapes 85.

According to the constitution, the difference in thickness between the portions 31 and 32 (which are each hereinafter referred to as a pad part precursor) corresponding respectively to the pad part 21 and 22 and the portion 33 (which is hereinafter referred to as a wiring part precursor) corresponding to the wiring part 23 in the precursor (conductor pattern precursor) 30 of the conductor pattern 20 can be decreased, thereby flattening the surface of the conductor pattern precursor 30 (see FIG. 8). According to the constitution, the conductor pattern 20 with high reliability prevented from suffering cracking, breakage of wiring or the like can be efficiently formed.

In particular, the difference in thickness between the pad part precursors 31 and 32 and the wiring part precursor 33 can be decreased in both cases where the dimensions of the pad parts 21 and 22 are large and small, and good reproducibility can also be obtained.

The clusters of the first pixels 811 are disposed concentrically, and therefore, the difference in thickness between the pad part precursors 31 and 32 and the wiring part precursor 33 can be certainly decreased when the wiring part 23 is connected to any position on the outer periphery of the pad parts 21 and 22. According to the constitution, the case where plural wiring parts 23 are connected to the pad parts 21 and 22 can be easily handled.

The advantage cannot be obtained when the first pixels 811 are simply thinned (for example, a staggered arrangement) in the portions 82 and 83 corresponding to the pad parts of the bitmap 8.

The form of the annular shapes 85 is not limited to the circular shape but may be, for example, an elliptic shape, a polygonal shape, such as square, or the like.

The annular shapes 85 in the bitmap 8 are preferably spaced from each other. Specifically, it is preferred that the two annular shapes 85 adjacent to each other are not connected to each other, and a portion connecting the two annular shapes 85 adjacent to each other is not provided. According to the constitution, the difference in thickness between the pad part precursors 31 and 32 and the wiring part precursor 33 can be further decreased.

The first pixels 811 constituting the annular shapes 85 may be provided intermittently but are preferably provided continuously. According to the constitution, the difference in thickness between the pad part precursors 31 and 32 and the wiring part precursor 33 can be further decreased.

The pitch of the annular shapes 85 in the bitmap 8 is preferably from 8 to 70 μm, and more preferably from 25 to 55 μm. According to the constitution, the difference in thickness between the pad part precursors 31 and 32 and the wiring part precursor 33 can be further decreased.

The pitch of the annular shapes 85 is preferably from 10 to 45% of the diameter of the portion 82 corresponding to the pad part, and more preferably from 15 to 30% thereof. According to the constitution, the difference in thickness between the pad part precursors 31 and 32 and the wiring part precursor 33 can be further decreased.

In the portions 82 and 83 corresponding to the pad parts of the bitmap 8, the ratio of the area occupied by the first pixels 811 is preferably from 30 to 75%, and more preferably from 40 to 60%. According to the constitution, the difference in thickness between the pad part precursors 31 and 32 and the wiring part precursor 33 can be further decreased.

### Formation of Conductor Pattern Precursor

Droplets of the ink are ejected based on the bitmap data by using the ink-jet apparatus 100 onto the ceramics green sheet 7 by a liquid droplet ejecting method, and then dried to form the conductor pattern precursor 30 shown in FIG. 8 on the ceramics green sheet 7 (Step S102).

At this time, the controlling device 190 of the ink-jet apparatus 100 controls the operations of the members constituting the ink-jet apparatus 100, such as the first moving unit 171, the second moving unit 181, the head 110, the rubber heater 150 and the like, based on the information including the bitmap data.

The ink-jet apparatus 100 moves the ceramics green sheet 7 placed on the table 140 in the Y-axis direction (i.e., the head 110 and the table 140 are moved relatively) by the operation of the first moving unit 171, and ejects liquid droplets of the ink 200 from the prescribed nozzle 118 of the head 110 based on the bitmap data while the ceramics green sheet 7 is moved under the head 110, whereby the liquid droplets of the ink 200 are attached to (reach) the prescribed positions of the ceramics green sheet 7. The operation may be hereinafter referred to as a main scanning of the head 110 and the ceramics green sheet 7 (substrate S), or referred simply to as a main scanning.

The main scanning of the head 110 and the ceramics green sheet 7 and movement of the head 110 in the X-axis direction by the operation of the second moving unit 181 (which may be referred to as a subscanning) are repeated alternately, and the ink droplets are attached to (reach) the conductor pattern forming region on the ceramics green sheet 7 where the conductor pattern 20 (conductor pattern precursor 30) is to be formed. At this time, the ink droplets are ejected in such a manner that the positions where the ink droplets are attached (reach) form plural concentric annular shapes within the pad forming region on the ceramics green sheet 7 where the pad parts 21 and 22 (pad part precursors 31 and 32) are formed. In this embodiment, the ink droplets are ejected in such a manner that the positions where the ink droplets are attached form plural concentric circular shapes.

According to the operation, the difference in thickness between the pad part precursors 31 and 32 and the wiring part precursor 33 can be decreased, thereby flattening the surface of the conductor pattern precursor 30. Consequently, the conductor pattern 20 with high reliability prevented from suffering cracks, breakage of wiring or the like can be efficiently formed.

The order of the attachment of the ink droplets may not follow the circles. This will be described later.

In the ink droplets attached to the ceramics green sheet 7, the center distance of two liquid droplets that are adjacent to each other in the radial direction of the annular shapes 85 (i.e., the distance corresponding to L1 shown in FIG. 9) is larger than the center distance of two liquid droplets that are adjacent to each other in the longitudinal direction of the line constituting the annular shapes 85 (i.e., the distance corresponding to L2 shown in FIG. 9). According to the constitution, the difference in thickness between the pad part precursors 31 and 32 and the wiring part precursor 33 can be further decreased.

In this embodiment, the table 140 is heated by the operation of the rubber heater 150, and the ceramics green sheet 7 is heated through the table 140, whereby the entire upper surface of the ceramics green sheet 7 is heated to the prescribed temperature.

At least a part of the aqueous dispersion medium is evaporated from the surface side of the ink 200 reaching the ceramics green sheet 7. At this time, the ceramics green sheet 7 is heated, and thus evaporation of the aqueous dispersion medium is accelerated, thereby decreasing efficiently the content of the aqueous dispersion medium in the layer where the metal particles are concentrated (i.e., the conductor pattern precursor 30).

The heating temperature of the ceramics green sheet 7 is not particularly limited and may be determined in consideration of various conditions. The heating temperature is preferably such a temperature that is higher than the temperature of the ink 200 upon being ejected and is lower than the boiling point of the dispersion medium (which is the lowest boiling point when plural kinds of liquid are contained in the aqueous dispersion medium) of the ink 200. Specifically, the heating temperature of the ceramic green sheet 7 is preferably 40° C. or more and less than 100° C., and more preferably from 50 to 70° C. According to the constitution, the ink 200 can be quickly dried without bumping (boiling) of the aqueous dispersion medium.

The conductor pattern precursor 30 thus formed may be further dried. The drying may be performed under the similar conditions as in the heating temperature of the ceramics green sheet 7 upon ejecting the liquid droplets.

The conductor pattern precursor 30 is thus formed on the ceramics green sheet 7 in this manner.

The pad part precursors 31 and 32 of the conductor pattern precursor 30 are each formed continuously. The wiring part precursor 33 thereof is also formed continuously. Accordingly, the entire conductor pattern precursor 30 is formed continuously. According to the constitution, the conductor pattern 20 with high reliability can be formed.

The difference between the maximum value a of the thickness of the pad part precursors 31 and 32 and the maximum value b of the thickness of the wiring part precursor 33 is preferably 10 μm or less (provided that 0 is included), and more preferably 5 μm or less (provided that 0 is included). According to the constitution, the conductor pattern 20 can be prevented from suffering cracking, breakage of wiring or the like, thereby providing the conductor pattern 20 with high reliability.

The value |a−b|/a is preferably 0.3 or less (provided that 0 is included), and more preferably 0.2 or less (provided that 0 is included). According to the constitution, the conductor pattern 20 can be prevented from suffering cracking, breakage of wiring or the like, thereby providing the conductor pattern 20 with high reliability.

In this embodiment, as shown in FIG. 10, a cluster of plural pixels 81 in the bitmap 8 is designated as one unit. In the constitution shown in the figure, 16 pixels 81 arranged in matrix form with four pixels in row and four pixels in column are designated as one unit, and the case where the 16 pixels are handled as one unit is described below as a representative example.

In this constitution, the ink droplets are ejected in the order of the numerals shown in the figures, thereby attaching the ink to the ceramics green sheet 7 corresponding to the one unit of the cluster of the pixels 81 by 16 times of the main scanning (i.e., performing divided drawing).

Specifically, the ink droplets are ejected to the pixels 81 indicated with the number N (wherein N is an integer of from 1 to 16) in the Nth main scanning, provided that the ink is ejected in the case where the pixel 81 is the first pixel 811 corresponding to the position where the ink droplet is attached, but the ink is not ejected in the case where the pixel 81 is the second pixel 812 corresponding to the position where the ink droplet is not attached.

The case where the 16 pixels 81 of one unit are all the first pixels 811 is exemplified. As shown in FIG. 10, the ink droplets 51 are ejected in the first main scanning in such a manner that two liquid droplets 51 adjacent to each other are spaced from each other after reaching the ceramics green sheet 7. Accordingly, the liquid droplets 51 adjacent to each other on the ceramics green sheet 7 are prevented from suffering such a phenomenon that two liquid droplets 51 are attracted to each other by the surface tension or the like to concentrate the ink locally. According to the constitution, the difference in thickness between the pad part precursors 31 and 32 and the wiring part precursor 33 can be further decreased.

In the subsequent second main scanning, as shown in FIG. 11, the ink droplets 52 are ejected to the positions between the two liquid droplets 51 adjacent to each other attached to the ceramics green sheet 7 in the first main scanning. By this operation, the two liquid droplets 51 adjacent to each other attached in the first main scanning are connected to each other with the liquid droplets 52 attached in the second main scanning. At this time, the liquid droplets 51 are dried as compared to the state immediately after reaching the ceramics green sheet 7, and therefore, no problem occurs upon being in contact with the liquid droplets 52, thereby preventing the ink from being concentrated locally. The liquid droplets 52 are ejected in such a manner that two liquid droplets 52 adjacent to each other are spaced from each other after reaching the ceramics green sheet 7, as similar to the liquid droplets 51. The descriptions relating to the subsequent main scanning operations are omitted herein.

The thickness of the conductor pattern 30 can be controlled by adjusting the ejection conditions of the ink 200. Specifically, for forming the portion of the conductor pattern precursor 30 with a large thickness, the ejection amount (or the number of liquid droplets) of the ink 200 per unit area in the portion is increased, and for forming the portion of the conductor pattern precursor 30 with a small thickness, the ejection amount (or the number of liquid droplets) of the ink 200 per unit area in the portion is decreased.

In the case where the ink 200 contains a drying inhibitor after evaporating the dispersion medium, the conductor pattern precursor 30 may not outflow even when the pattern is not completely dried. Accordingly, such an operation can be employed that the ink 200 that has been once attached and dried is allowed to stand for a prolonged period of time, and then the ink 200 is again attached.

In the case where the ink 200 contains the organic binder, the organic binder (particularly the polyglycerin compound) is chemically and physically stable, and therefore, the ink 200 is not denatured even when the ink 200 that has been once attached and dried is allowed to stand for a prolonged period of time. Therefore, the ink 200 can be attached again, thereby providing a uniform pattern. According to the constitution, the conductor pattern precursor 30 itself does not have a multilayer structure, and consequently, the conductor pattern 20 is prevented from suffering such a phenomenon that the specific resistance between the layers is increased to increase the specific resistance of the entire conductor pattern 20.

The conductor pattern 20 in this embodiment can be formed to have a larger thickness by the process mentioned above, as compared to a conductor pattern formed with an ordinary ink. More specifically, a conductor pattern having a thickness of 5 μm or more can be formed.

After forming the conductor pattern precursor 30 in this manner, the necessary number, for example, from 10 to 20 plies, of the ceramics green sheets 7, on each of which the conductor pattern 30 has been formed in the same manner, are produced.

### Lamination

Subsequently, the PET film is released from each of the ceramics green sheets 7, which are then laminated on each other to provide a laminated body 12.

At this time, the ceramics green sheets 7 to be laminated are disposed in such a manner that the conductor pattern precursors 30 of the ceramics green sheets 7 to be laminated are connected to each other, depending on necessity, through the contact 6.

Thereafter, the laminated ceramics green sheets 7 are adhered by pressing under heating to a temperature equal to or higher than the glass transition temperature of the binder constituting the ceramics green sheet 7. The laminated body 12 is thus obtained.

### Firing

The laminated body 12 thus obtained is then subjected to a heat treatment (i.e., a firing treatment), for example, with a belt furnace. The ceramics green sheets 7 are thus sintered to form ceramics substrates 2 as shown in FIG. 5B, and the conductor pattern precursors 30 are formed into circuits (conductor patterns) 20 containing wiring patterns and electrode patterns through sintering of the silver particles (metal particles) constituting the conductor pattern precursors 30. The circuit 4 is also formed in the similar manner as the circuits 20. In summary, the laminated body 12 is converted to the laminated substrate 3 through the heat treatment.

The heating temperature (firing temperature) of the laminated body 12 is preferably a temperature equal to or higher than the softening point of the glass contained in the ceramics green sheets 7, and specifically is preferably from 600 to 900° C. As the heating conditions, the temperature may be increased and decreased at an appropriate rate, and the highest heating temperature, i.e., the aforementioned temperature of from 600 to 900° C., may be maintained for an appropriate period depending on the temperature.

The heating temperature is increased to a temperature equal to or higher than the softening point of the glass, i.e., a temperature within the aforementioned range, whereby the glass component of the ceramics substrates 2 to be obtained can be softened. Accordingly, the heated laminated body is then cooled to an ordinary temperature for hardening the glass component, whereby the ceramics substrates 2 and the circuits (conductor patterns) 20 constituting the laminated substrate 3 are fixed further firmly.

In particular, the laminated body is heated to a temperature equal to or lower than 900° C., whereby the resulting ceramics substrate 2 is low temperature co-fired ceramics (LTCC).

The metal particles constituting the conductor pattern precursors 30 provided on the ceramics green sheets 7 are fused and connected to each other by the heat treatment, thereby exhibiting electroconductivity.

The circuits 20 are each connected directly to the contact 6 in the ceramics substrate 2 through the heat treatment, and thus the circuits 20 are electrically connected to each other. If the circuit 20 is simply placed on the ceramics substrate 2, the mechanical connection strength to the ceramics substrate 2 cannot be ensured, and thus the circuit may be broken on receiving an impact or the like. In this embodiment, however, the glass component in the ceramics green sheet 7 is once softened and the hardened, whereby the circuit 20 is firmly fixed to the ceramics substrate 2. Therefore, the circuit 20 thus formed has high mechanical strength.

In the production method of the ceramics circuit board 1, the conductor pattern forming ink 200 is attached to the ceramics green sheet 7 upon producing each of the ceramics substrates 2 constituting the laminated board 3, and therefore, the conductor patterns 20 with intended shapes can be formed with high accuracy.

Therefore, the embodiment of the invention can cope with the demand of miniaturization of an electronic device as a constitutional element of an electronic apparatus, and also can cope with the demand of small-volume production with great varieties.

Furthermore, the heating temperature of the heat treatment of the ceramics green sheets 7 is equal to or higher than the softening temperature of the glass contained in the ceramics green sheets 7, whereby the conductor patterns 20 thus formed are firmly fixed to the ceramics substrates 2 (ceramics green sheets 7) upon converting the ceramics green sheets 7 to the ceramics substrates 2 through the heat treatment, and thus the mechanical strength of the conductor patterns 20 can be increased.

In the conductor pattern 20 of the ceramics circuit board 1 thus obtained in the manner mentioned above, the silver particles are connected to each other, and at least on the surface of the conductor pattern 20, the silver particles are bound without gap.

The specific resistance of the conductor pattern 20 is preferably less than 20 μΩcm, and more preferably 15 μΩcm or less. The specific resistance herein means the specific resistance after the ink is applied and then dried by heating to 160° C. When the specific resistance is 20 μΩcm or more, the conductor pattern is difficult to be applied to such a purpose that requires electroconductivity, such as an electrode formed on a circuit board.

The conductor pattern 20 can be applied to a high-frequency module of a mobile communication device, such as a cellular phone and a PDA, an interposer, MEMS (microelectromechanical systems), an acceleration sensor, a surface acoustic device, a deformed electrode, such as an antenna and an interdigitated electrode, electronic parts of various kinds of measuring instruments, and the like.

The ceramics circuit board 1 may be applied to an electronic parts used in various kinds of electronic instruments, and may contain a circuit pattern containing various wirings and electrodes, a laminated ceramics capacitor, a laminated inductor, an LC filter, a composite high-frequency part, and the like integrated in the substrate.

The embodiment of the invention has been described with reference to the preferred embodiments, but the invention is not limited thereto. An arbitrary process step may be added to the invention.

For example, in the aforementioned embodiment, the case where the colloid liquid is used as the conductor pattern forming ink is described as a representative example, but the conductor pattern forming ink may not be a colloid liquid.

In the embodiment, the conductor pattern forming ink contains silver particles dispersed therein, but other metals than silver may be used. Examples of the metal constituting the metal particles include silver, copper, palladium, platinum, gold and alloys thereof, which may be used solely or as a combination of two or more of them. In the case where the metal particles are an alloy, the alloy may contain at least one of the aforementioned metals as a major component and may contain the other metals. The metals may be an alloy containing the aforementioned metals mixed at an arbitrary ratio. Furthermore, mixed particles (for example, a mixture of silver particles, copper particles and palladium particles at an arbitrary ratio) dispersed in a liquid may be used. These metals have a small resistivity and is stable as not being oxidized under heating, and thus the use of the metals enables formation of a stable conductor pattern with low resistance.

In the embodiment, the case where the conductor pattern forming ink contains an aqueous dispersion medium as a dispersion medium for dispersing the metal particles is described as a representative example, but the conductor pattern forming ink may contain, as the dispersion medium, water and/or a non-aqueous dispersion medium (i.e., an oily dispersion medium), which is a liquid that is poor in compatibility with water (for example, a liquid having a solubility of less than 30 g with respect to 100 g of water at 25° C.)

In the embodiment, the piezoelectric system is used as the liquid droplet ejecting method, but it is not limited thereto, and various known techniques, such as a system of ejecting an ink with bubbles formed by heating the ink, and an electrostatic system using an electrostatic actuator, may be employed.

In the embodiment, the liquid droplet ejecting head is moved in the X-axis direction, and the table (substrate) is moved in the Y-axis direction, but the constitution is not limited thereto, and it is sufficient that the liquid droplet ejecting head and the table (substrate) are moved relatively in the X-axis direction and the Y-axis direction (i.e., the liquid droplet ejecting head is moved in the X-axis direction and the Y-axis direction relatively to the table). Other examples of the constitution include a constitution, in which the liquid droplet ejecting head is moved in the Y-axis direction, and the table is moved in the X-axis direction, a constitution, in which the liquid droplet ejecting head is moved in both the X-axis direction and the Y-axis direction, and a constitution, in which the table is moved in both the X-axis direction and the Y-axis direction.

In the embodiment, the wiring board is a multilayer substrate, but the wiring board is not limited thereto, and may be, for example, a single layer substrate.

The substrate (including a precursor thereof) is not particularly limited, and examples thereof include substrates formed of an alumina sintered body, a polyimide resin, a phenol resin, a glass fiber-reinforced epoxy resin, glass or the like, and a ceramics molded article in the form of sheet constituted by materials including ceramics and a binder.

The entire disclosure of Japanese Patent Application No. 2010-005343, filed Jan. 13, 2010 is expressly incorporated by reference herein.

What is claimed is:

1. A method for forming a conductor pattern, comprising:
forming a conductor pattern precursor by ejecting liquid droplets of a conductor pattern forming ink by a liquid droplet ejecting method onto a substrate, and drying the liquid droplets, thereby forming a conductor pattern precursor having a pad part and a wiring part connected to the pad part on the substrate; and
firing the precursor, thereby forming the conductor pattern,
wherein in the formation of the conductor pattern precursor, the liquid droplets of the conductor pattern forming ink are ejected in such a manner that positions where the liquid droplets of the conductor pattern forming ink are attached form plural concentric annular shapes within a pad forming region where the pad part is to be formed on the substrate.

2. A method for forming a conductor pattern, comprising:
forming a bitmap data expressing a bitmap containing plural pixels disposed in matrix form based on a design data of a conductor pattern having a pad part and a wiring part connected to the pad part;
forming a conductor pattern precursor by ejecting liquid droplets of a conductor pattern forming ink by a liquid droplet ejecting method onto a substrate based on the bitmap data, and drying the liquid droplets, thereby forming a precursor of the conductor pattern on the substrate; and
firing the precursor, thereby forming the conductor pattern,
wherein in the formation of the bitmap data, the pixels are disposed in such a manner that clusters of the pixels corresponding to positions where the liquid droplets of the conductor pattern forming ink are attached form plural concentric annular shapes within a portion of the bitmap corresponding to the pad part.

3. The method for forming a conductor pattern according to claim 2, wherein a pitch of the pixels is ½ or less (provided that 0 is excluded) of a diameter of the liquid droplet of the conductor pattern forming ink after reaching the substrate.

4. The method for forming a conductor pattern according to claim 2, wherein in the portion of the bitmap corresponding to the pad part, a ratio of an area occupied by the clusters of the pixels corresponding to positions where the liquid droplets of the conductor pattern forming ink are attached is from 30 to 75%.

5. The method for forming a conductor pattern according to claim 1, wherein the plural annular shapes are spaced from each other.

6. The method for forming a conductor pattern according to claim 1, wherein in the liquid droplets of the conductor pattern forming ink attached to the substrate, a center distance of two liquid droplets that are adjacent to each other in the radial direction of the annular shapes is larger than a center distance of two liquid droplets that are adjacent to each other in the longitudinal direction of a line constituting the annular shapes.

7. The method for forming a conductor pattern according to claim 1, wherein the portion corresponding to the pad part of the precursor is formed continuously.

8. The method for forming a conductor pattern according to claim 1, wherein the precursor has a value |a−b|/a of 0.3 or less (provided that 0 is included), wherein a represents a maximum value of a thickness of the portion corresponding to the pad part of the precursor, and b represents a maximum value of a thickness of the portion corresponding to the wiring part of the precursor.

9. The method for forming a conductor pattern according to claim 1, wherein in the formation of the conductor pattern precursor, the liquid droplets of the conductor pattern forming ink are ejected onto the substrate from a liquid droplet ejecting head ejecting the liquid droplets of the conductor pattern forming ink, while moving relatively the liquid droplet ejecting head and the substrate,
in such a manner that in a first scanning, after the liquid droplets of the conductor pattern forming ink reach the substrate, two liquid droplets that are adjacent to each other are spaced from each other.

10. The method for forming a conductor pattern according to claim 1, wherein the conductor pattern forming ink contains metal particles and a dispersion medium having the metal particles dispersed therein, and
in the formation of the conductor pattern precursor, the substrate is heated to a temperature that is higher than a temperature of the conductor pattern forming ink upon being ejected and is lower than a boiling point of the dispersion medium.

11. The method for forming a conductor pattern according to claim 1, wherein the substrate is a ceramic molded article constituted by a material containing a ceramic material and a binder, and
in the firing, the ceramic molded article and the precursor are fired to form the conductor pattern on a ceramic substrate.

12. A liquid droplet ejecting apparatus comprising:
a table that supports a substrate;
a liquid droplet ejecting head that ejects liquid droplets of a conductor pattern forming ink to the substrate supported by the table;
a moving mechanism that moves relatively the table and the liquid droplet ejecting head; and
a controlling unit that controls operations of the liquid droplet ejecting head and the moving mechanism,
wherein upon forming a conductor pattern having a pad part and a wiring part connected to the pad part on the substrate, the controlling unit controls the operations of the liquid droplet ejecting head and the moving mechanism in such a manner that while moving relatively the table and the liquid droplet ejecting head with the moving mechanism, the liquid droplets of the conductor pattern forming ink are ejected from the liquid droplet ejecting head in such a manner that positions where the liquid droplets of the conductor pattern forming ink are attached form plural concentric annular shapes within a pad forming region where the pad part is to be formed on the substrate.

13. A liquid droplet ejecting apparatus comprising:
a table that supports a substrate;
a liquid droplet ejecting head that ejects liquid droplets of a conductor pattern forming ink to the substrate supported by the table;
a moving mechanism that moves relatively the table and the liquid droplet ejecting head;
a bitmap data forming unit that forms a bitmap data expressing a bitmap containing plural pixels disposed in matrix form based on a design data of a conductor pattern having a pad part and a wiring part connected to the pad part; and
a controlling unit that controls operations of the liquid droplet ejecting head and the moving mechanism,
wherein the bitmap data forming unit disposes the pixels in such a manner that clusters of the pixels corresponding to positions where the liquid droplets of the conductor pattern forming ink are attached form plural concentric annular shapes within a portion of the bitmap corresponding to the pad part, and
the controlling unit controls based on the bitmap data the operations of the liquid droplet ejecting head and the moving mechanism in such a manner that the liquid droplets of the conductor pattern forming ink are ejected onto the substrate from the liquid droplet ejecting head while moving relatively the table and the liquid droplet ejecting head with the moving mechanism.
